(19) United States
(12) Patent Application Publication
(10) Pub. No.: US 2003/0163426 A1
(43) Pub. Date: Aug. 28, 2003

(54) Method and system for controlling transaction fees for automatic teller machines

(75) Inventors: Jian Zhang, Yokohama (JP); Yoshitaka Nakata, Yokohama (JP); Yoshitsugu Morooka, Tokyo (JP); Seiji Futatsugi, Kawasaki (JP); Hiroyuki Miyazaki, Yokohama (JP); Takeshi Ieshima, Yokohama (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/313,788

(22) Filed: Dec. 6, 2002

(30) Foreign Application Priority Data
Feb. 22, 2002 (JP) 2002-045568

(51) Int. Cl. G06F 17/60

(52) U.S. Cl. 705/43

(57) ABSTRACT

A fee management system for managing ATM fees at an ATM that is installed at a business establishment and is connected to a server via a network. The fee management system includes a section that designates a purchase of a merchandise card at the ATM and informs the server of the purchase via the network, and a section that calculates an amount to be discounted from an ATM transaction fee when applicable. The fee management system also includes a section that, when a transaction fee is charged for a transaction at the ATM, subtracts at least a part of the amount of the transaction fee to be discounted from an account of a business establishment where the merchandise card can be used.

### BACKGROUND OF THE INVENTION

1. Field of the Invention

The present invention relates to a method and system for controlling transaction fees for automatic teller machines (ATM), especially for ATMs installed within retail establishments such as convenience stores.

2. Description of Related Art

Conventionally, ATMs are generally installed at banks. And, if the bank issuing the customer an ATM card and the bank in which the ATM is installed are the same, there is no transaction fee charged to the customer during normal day time hours. If transactions take place at night, or during Saturdays and holidays, however, the fee is subtracted from the customer's account. Also, if the bank issuing the ATM card and the bank at which the ATM is installed are not the same, the transaction fee is subtracted from the account even during normal work hours.

To alleviate the customers' burden of paying transaction fees, an ATM has been proposed that allows the customer to play a game during non-regulation hours for transaction and not charging a transaction fee, providing the customer wins the game.

Also, another automatic teller system proposed does not collect transaction fees from customers to Bank A even if the ATM is installed at a different Bank B if they are frequent customers to Bank A and the ATM cards were issued by Bank A.

More recently, ATMs are installed at retail stores, including convenience stores. However, if a customer withdraws cash from an ATM installed at a retail store, a transaction fee is charged for cash withdrawals from the account of other banks, and for cash withdrawals from the same bank issuing the card at nights, or during Saturdays, Sundays or holidays.

For customers it is desirable to lessen the transaction fees of ATMs installed at retail sites. Owners of retail stores, on the other hand, would like to see customers purchase more goods from the store by installing an ATM.

### SUMMARY OF THE INVENTION

The present invention relates to a transaction fee management method and system for ATMs that enables to lessen ATM transaction fees for customers while enabling store owners to encourage customers to buy more merchandise from the stores.

In accordance with an embodiment of the present invention, an ATM fee discount system includes an ATM that may be installed at a store where the customer comes to make a purchase, wherein the ATM is connected to a bank server via a network. The ATM may inform, via the network, the bank server of the transaction the customer is about to make, and makes an indication that encourages the customer to purchase a merchandise card if there is a transaction fee charged for the transaction. In response to the customer's instruction to purchase a merchandise card, the transaction fee is discounted. Also, the amount of the transaction fee discount is determined by the amount of the merchandise card indicated in the purchase. Moreover, the amount of the transaction fee discount is subtracted from the account of the store at which the ATM is installed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows the entire configuration of an ATM fee discount system in accordance with the present invention.

FIG. 2 shows an example of a table of merchandise card information.

FIG. 3 shows an example of display of an option screen for selecting transactions.

FIG. 4 shows an example of display of an option screen for selecting transaction fee discount services.

FIG. 5 shows an example of display of an option screen for selecting stores to be used.

FIG. 6 shows an example of display of an option screen for selecting merchandise card amounts.

FIG. 7 shows an example of display for confirming a merchandise card transaction.

FIG. 8 shows an example of bank account information for retail stores.

FIG. 9 shows an example of customer account information.

FIG. 10 shows an example of display for confirming a merchandise card transaction at an ATM after a customer selects the amount of a merchandise card.

FIG. 11 shows a first flowchart of an ATM fee discount system.

FIG. 12 shows a second flowchart of an ATM fee discount system.

### DESCRIPTION OF PREFERRED EMBODIMENTS

An embodiment of the present invention is explained below with reference to the accompanying drawings.

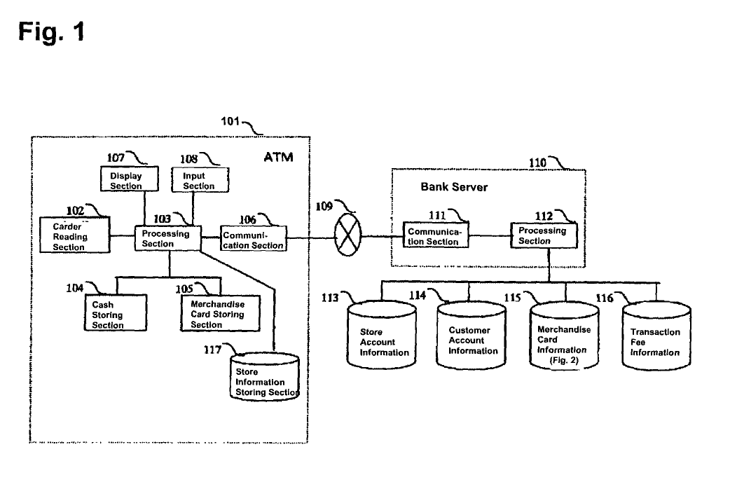

FIG. 1 shows an overall configuration of an ATM fee discount system in accordance with the present invention. The ATM fee discount system includes an ATM 101 that is installed at a retail establishment such as a convenience store. The ATM 101 includes a card reading section 102 for reading the customer's cash card, a processing section 103 that performs various processings within the ATM, a cash storing section 104, a merchandise card storage section 105 which houses merchandise cards that can be used at stores equipped with the ATM 101 and at other stores, a communication section 106 that connects the ATM 101 to an external network, a display section 107 which displays the ATM 101 's message to the customer, an input section 108 which receives the customer's input to the ATM 101 and an information 117 concerning the store in which the ATM 101 is installed.

Reference numeral 109 denotes a network with which the ATM 101 and the bank server 110 communicate.

Reference numeral 110 denotes a bank server for performing banking operations. The bank server 110 includes a communication section 111 that processes communication via the network 109 and a processing section 112 which processes bank operations. The processing section 112 may be connected to a variety of information storage sections containing various information 113, 114, 115 and 116. Reference numeral 113 denotes bank account information for the retail store where the ATM 101 is installed. It is noted that the bank account information 113 may contain bank account information for a plurality of retail stores where ATMs are installed, respectively. Reference numeral 114 denotes customers' bank account information, and reference numeral 115 denotes merchandise card information which contains information on merchandise cards and discount information on transaction fees when the customers purchases merchandise cards. Reference numeral 116 denotes information on transaction fees for the ATM 101.

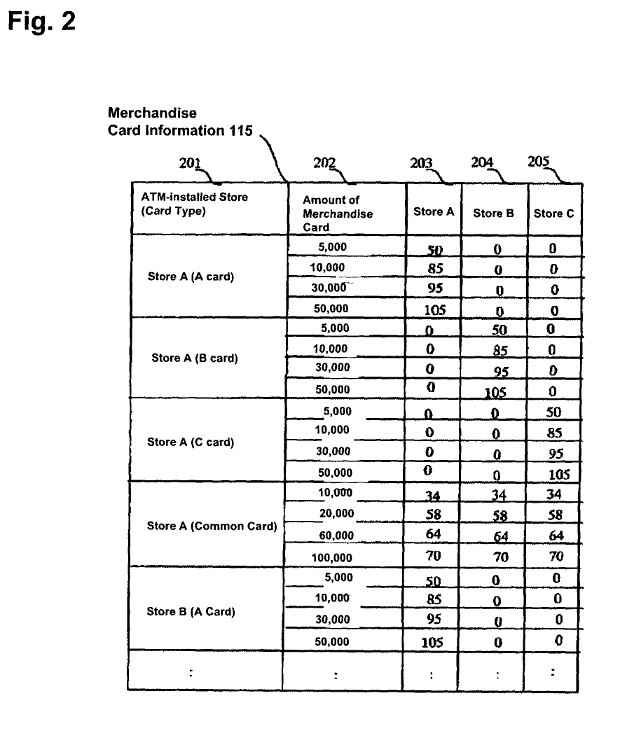

FIG. 2 shows an example of the merchandise card information 115. Reference numeral 201 denotes the names of the stores where the ATMs 101 are installed and the interlinking relationship between the stores and the merchandise cards that can be purchased with the ATM at the stores. For example, the merchandise card information 115 shows that A card, B card, C card and common card can be purchased at the ATM at Store A, and that the A card can be purchased at the ATM at Store B. Reference numeral 202 denotes the amount for the merchandise cards. For example, the merchandise card information 115 indicates that there are A, B and C merchandise cards in the amounts of 5,000 yen, 10,000 yen, 30,000 yen and 50,000 yen, and common cards in the amounts of 10,000 yen, 20,000 yen, 60,000 yen and 100,000 yen. Columns 203, 204 and 205 show the amount of transaction fees the respective retail stores will have to bear when the customer selects a discount for the transaction fee. First, the outline of the transactions will be described, and details thereof will be described later.

For example, the column 203 indicates that if a 5,000 yen A card is purchased, Store A bears 50 yen in the ATM transaction fee. Also, if a 10,000 yen A card is purchased at Store A, the store bears 85 yen of the ATM transaction fee. Moreover, if B card (or C card) is purchased at Store A, the store will not bear any of the ATM transaction fee. If a 10,000 yen common card is purchased at Store A, Stores A, B and C shall bear 34 yen each in the ATM transaction fee, which means that the total burden of the ATM transaction fee will be 102 yen.

Also, the column 204 indicates that when a 5,000 yen A card is purchased at Store B, Store A will bear about 50 yen of the ATM transaction fee while Stores B and C will bear none of the expenses.

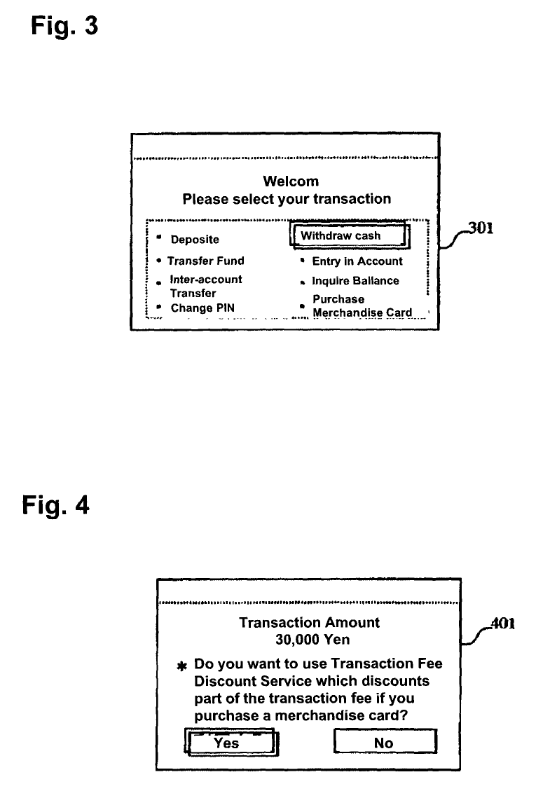

FIG. 3 shows an example of a transaction option screen 301 which is shown on the display section 107 through the controls of the procession section 103 when the customer selects the type of transaction via the ATM 101. The transaction option screen 301 has transaction selection buttons that allow the customer to make a deposit, withdraw cash, transfer funds, making inter-account transfer, inquire the balance and purchase merchandise cards. Of these, the merchandise card purchase button is characteristic to the embodiment of the present invention. The usage of this card purchasing button shall be explained in greater detail later.

FIG. 4 is an example of a transaction option screen 401 for transaction fee discounts that allows the customer to select whether or not to seek fee discount service when the customer uses part or all of the funds being withdrawn to purchase a merchandise card. As shown in FIG. 4, the fee discount service option screen 401 has a button for selecting fee discount service, and a button for not selecting the service. The usage of these buttons shall be explained later.

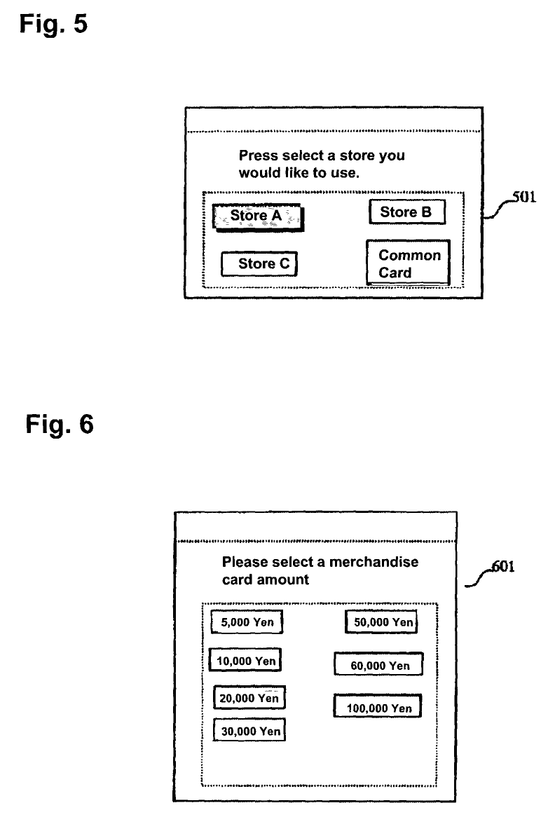

FIG. 5 shows an example of a screen 501 for selecting the store to be used in the selection of the merchandise card when the customer purchases a merchandise card and uses the fee discount service. The store selection screen 501 allows the purchase of A card when Store A is selected, B card when Store B is selected, C card when Store C is selected and Common card when Common card is selected as shown in FIG. 5. The usage of these buttons is explained later.

FIG. 6 shows an example of a merchandise card amount selection screen 601 for selecting the amount of the merchandise card when using the fee discount service after the customer purchases a merchandise card. This screen 601 has buttons for selecting the amount of the merchandise cards the customer would like to have as shown in FIG. 6. The usage of the buttons is explained later.

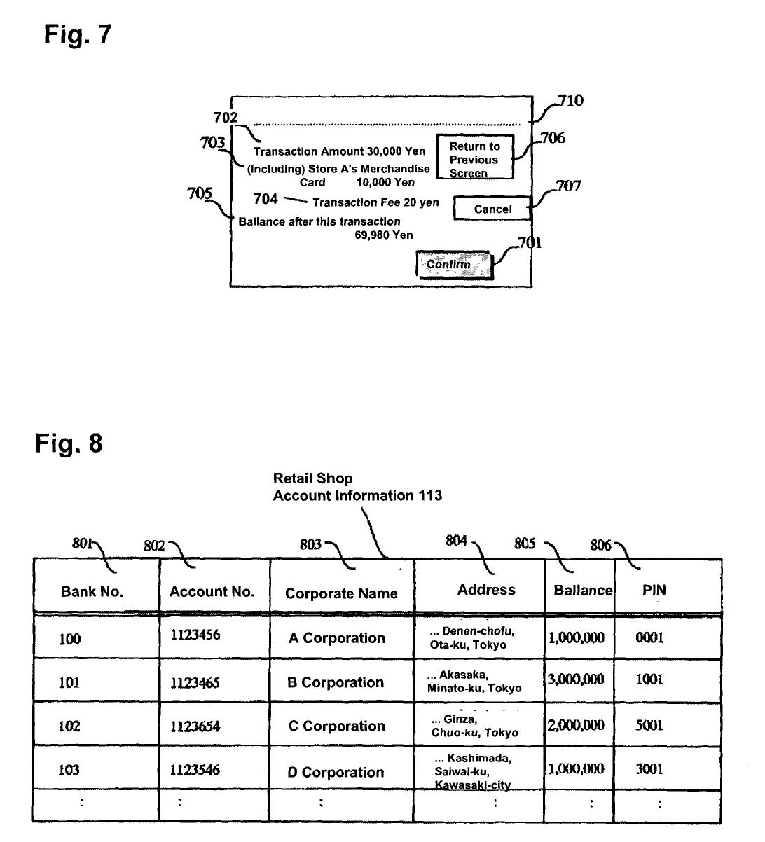

FIG. 7 shows an example of a transaction verification screen 710 which is displayed after the merchandise card is selected with the withdrawal of cash when the customer purchases a merchandise card in order to use the fee discount service. The transaction verification screen 710 has the verification button 701 for allowing the customer to verify the transaction from the screen to decide on the transaction. It also shows the amount of cash being withdrawn 702, the amount of merchandise card purchase 703 from the cash withdrawn, the amount of transaction fee to be paid by the customer 704, the customer's bank account balance 705 after the transaction, the button 706 for returning to the screen preceding the present transaction screen and the button 707 for canceling the transaction.

FIG. 8 shows an example of retail store account information 113. The retail store account information 113 contains information for the numbers for banks (bank branches) 801, account numbers 802, corporate names 803 of the owners of the account numbers 802, addresses of the corporations 804 with the corporate names 803, and balances 805 in the accounts of the customers with the account numbers 802. Reference numeral 806 denotes personal identification numbers used for doing ATM transaction with the accounts of the account number 802.

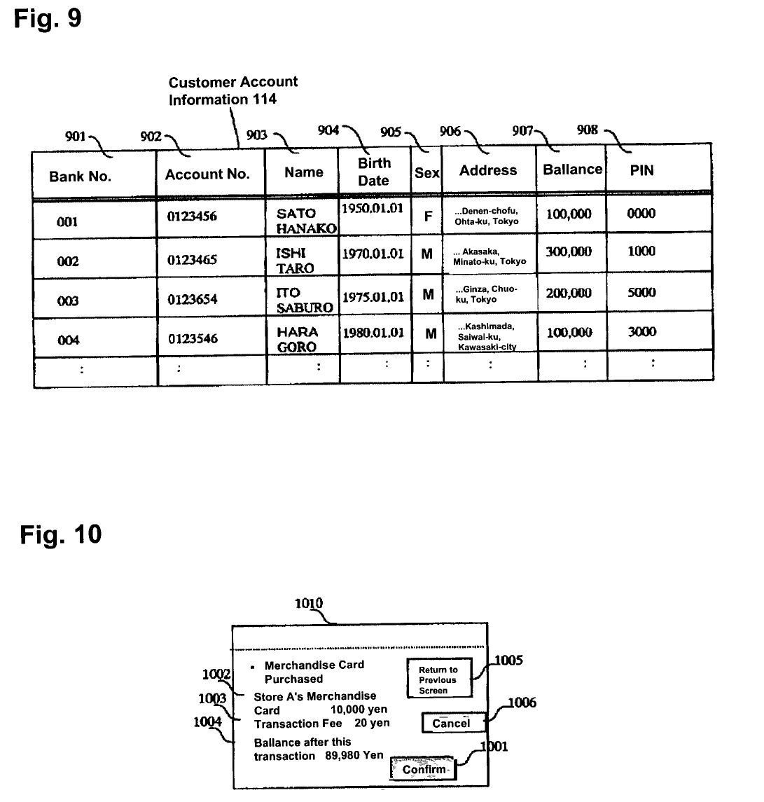

FIG. 9 is an example of customers' account information 114. The customers' account information 114 includes information for bank (branch of the bank) numbers 901 where the customers have their respective accounts, customer's account numbers 902, names of the customers 903 to whom the accounts belong, customers' birth dates 904, customers' gender 905, customers' addresses 906, the balance 907 in each of the customers' accounts, and personal identification numbers 908 used for performing transaction with the ATM 101.

FIG. 10 shows an example of a transaction verification screen 1010 which is shown after a merchandise card is selected when the customer performs a transaction to purchase a merchandise card and uses the fee discount fee service. The transaction verification screen 1010 includes a verification button 1001 for the customer to verify the transaction over the screen and implement the transaction. The transaction verification screen 1010 also includes a section 1002 that indicates the purchase amount for the merchandise card selected by the customer, a section 1003 that indicates the amount of the transaction fee to be paid by the customer, a section 1004 that indicates the balance in the customer's bank account after the transaction, a button 1005 for allowing the customer to return to the screen prior to the present transaction, and a button 1006 for canceling transactions.

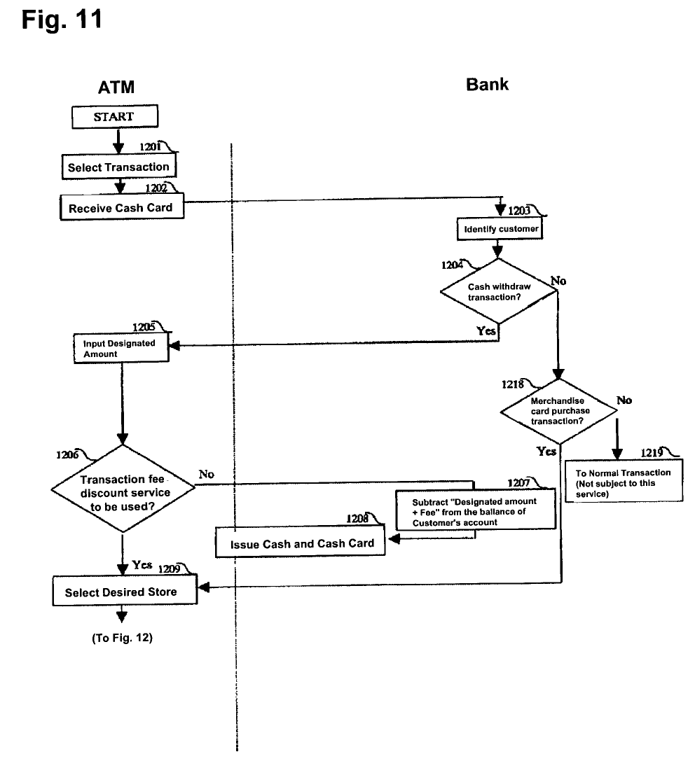

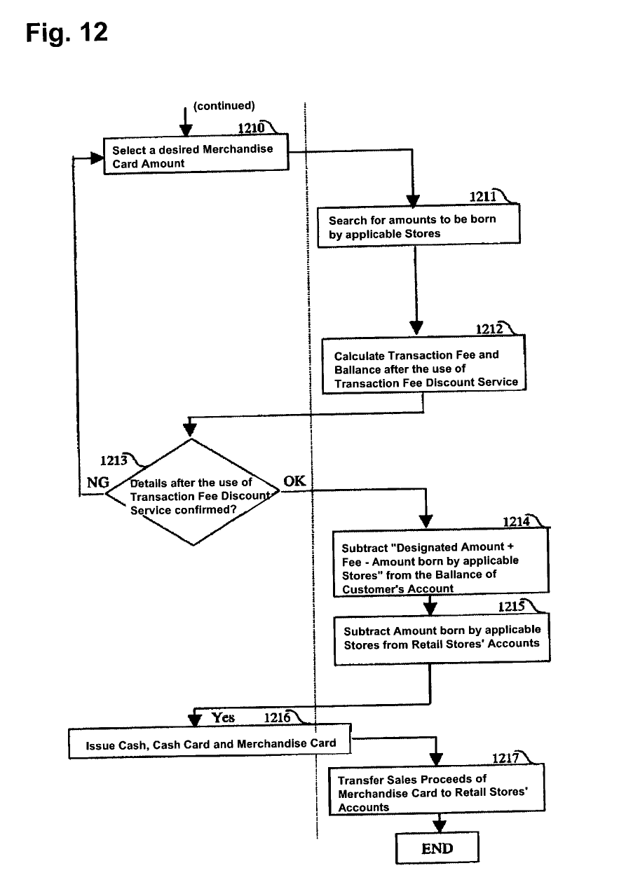

Operations of the ATM fee discount system will be described below with reference to flowcharts of FIGS. 11 and 12, and the other figures already explained above.

First, the customer selects (Step 1201) the transaction he or she wishes to make with the ATM 101. FIG. 3 is an example of a transaction option screen 301 for the customer to select the transaction, and the screen includes buttons to select various transactions such as depositing funds, withdrawing funds, transferring funds, making inter-account transfer, making balance inquiry and purchasing merchandise cards.

Next, the customer insert his or her bank account cash card into the ATM 101 and enters the personal identification number using the input section 108 (Step 1202).

The card reading section 102 reads the bank branch number in the cash card and the account information, while the processing section 103 uses the communication section 106 to send the type of transaction selected at Step 1201, the personal identification number input in Step 1202 and other information to the bank server 110 via the network 109. Next a verification of the customer is made (Step 1203) by matching the customer's account number and the personal identification number sent from the ATM with the bank number 901, the account number 902 and the personal identification number 908 in the customer account information 114.

Next, the processing section 112 is used to judge whether or not the transaction calls for a fund withdrawal (Step 1204). If the transaction is for fund withdrawal, the customer inputs the amount to be withdrawn from the input section 108 of the ATM 101 (Step 1205).

Next, the customer makes the decision (Step 1206) whether or not to use the fee discount service in the transaction if a transaction fee is to be charged. FIG. 4 is an example of a fee discount service option screen 401 to allow the customer to select whether or not the service will be sought. This screen includes a button for selecting the discount service and another button for not selecting the service.

When the selection is made not to use the fee discount service in Step 1206, the transaction amount is sent to the bank server 110 from the ATM 101, and the original balance amount minus the designated withdrawal amount plus the transaction fee is written into the balance 907 of the customer account information of FIG. 9 (Step 1207). Then, the designated amount of cash is withdrawn from the cash storing section 104 and is paid to the customer (Step 1208) together with the cash card accepted in Step 1202 from the ATM 101.

If the customer selects to use the fee discount service in Step 1206, the customer selects a retail store where a merchandise card to be purchased can be used. FIG. 5 is an example of the screen 501 for selecting the store to be used for making a purchase with the merchandise card. The customer uses this screen to select a store where the merchandise card can be used (Step 1209).

Next, the customer selects the amount (Step 1210) of the merchandise card to be purchased. FIG. 6 is an example of the merchandise card amount selection screen 601 for selecting the amount for the card.

Next, the information 117 of the store where the ATM is installed, the withdrawal amount input in Step 1205, the information on the store where the merchandise card selected in Step 1210 can be used and the amount for the merchandise card are sent to the bank server 110 from the ATM 101 via the network 109.

Next, the processing section 112 retrieves the merchandise card information 115 and searches for the purchase record of the subject merchandise card, and calculates the amount of the transaction fee burden on the store by matching the information on the store sent from its ATM 101, the information on the store where the merchandise card selected in Step 1209 can be used and the amount of the merchandise card selected in Step 1210. For example, the result of the search will indicate that Store A will bear 85 yen (Step 1211) of the transaction fee if Store A is selected as the desired retailer in Step 1209 of FIG. 5 in the ATM101 installed at Store A, and if the amount of 10,000 yen is selected for the desired merchandise card in Step 1209 of FIG. 9.

Next, the bank server 110 calculates the fee for this transaction from the fee information 116, and calculates the amount of fee to be borne by the customer after the store's share of the fee calculated in Step 1211 is subtracted from the fee amount. Next, the customer's account balance is retrieved from the account information 114, using the bank number 901 and account number 902 in the account information 114 sent from the ATM in Step 1203. A post-transaction balance is calculated (Step 1212) by subtracting the withdrawal amount and the fee to be borne by the customer from this customer's account balance.

Next, the customer would verify the details of the transaction over the screen, including the transaction amount input in Step 1205, the merchandise card selected in Step 1209, the amount of the merchandise card selected in Step 1210 and the transaction fee amount after using the fee discount service and the account balance following the transaction. FIG. 7 is an example of the transaction verifying screen 710 after the fee discount service is used. After verifying the transaction amount 702, the merchandise card amount 703, the transaction fee amount 704 after the fee discount service and the post-transaction balance 705, the customer selects the verification button 701 if the entries are correct. If the amount of the merchandise card to be purchased is to be altered, the customer selects the button 706 to return to the previous screen and back to Step 1210. If the transaction is to be cancelled this is done by selecting the cancellation button 807 (Step 1213).

Next, when the customer in Step 1213 verifies the particulars after using the transaction fee discount service and selects the verification button 701, the transaction is completed after subtracting from the account balance of the customer's account information 114 “the amount of designated transaction amount+Transaction Fee−the Fee to be Borne by the store” on the basis of the designated transaction amount input by the customer in Step 1205, the amount to be borne by the store retrieved in Step 1211 and the fee calculated in Step 1212, and by writing in the results to the customer's account balance.

For example, if a customer owning an account with the bank number of 001 and account number of 0123456 inputs 30,000 yen as the amount to be withdrawn in Step 1205, and selects Store A as the store to be used in Step 1209 of FIG. 5 through the ATM installed at Store A, and selects 10,000 yen as the amount for the desired merchandise card in Step 1210 shown in FIG. 6, the bank server 110 calculates the fee for this transaction from the transaction fee information 116. If, for example, the fee is 105 yen, the amount of 85 yen calculated in Step 1211 is subtracted from the fee as the amount to be borne by the store, leaving 20 yen as the fee amount to be borne by the customer. Next, from the original balance of 100,000 yen in the customer account information shown in FIG. 9, the designated withdrawal amount of 30,000 yen plus the transaction fee of 105 yen minus 85 yen to be borne by the store is subtracted, and the amount of 69,980 yen is written into the balance 107. (Step 1214)

Next, the store's share of the transaction fee discounted from the original customer fee in Step 1214 is subtracted from the balance 805 of the retail store's account information 113 in accordance with the fees 203, 204 and 205 in FIG. 2 to be borne by the respective retail stores, and written into the balance (Step 1215).

Next, the ATM 101 returns to the customer the cash card accepted in Step 1202, pays to the customer the cash from the cash storage section 104 after subtracting the amount for the merchandise card selected by the customer in Step 1210 from the designated withdrawal amount input by the customer in Step 1205, and issues the merchandise card purchased from the merchandise card storage section 105 (Step 1216).

Finally, the bank server 110 sends the sales proceeds for the merchandise card selected by the customer in Step 1210 to the accounts of the retail stores (Step 1217) by adding to and writing in the amount of the merchandise card to the account information balance 805 of the respective retail stores in accordance with the transaction fee ratio borne by the stores in Step 1215.

Also, if the transaction selected by the customer in Step 1204 is not a fund withdrawal type transaction, the processing section 112 is used to judge (Step 1218) whether or not the transaction selected by the customer in Step 1201 is for merchandise card purchase. If the transaction does not call for a withdrawal, the normal bank transaction is continued (Step 1219).

If a merchandise card transaction is called for in Step 1218, the process proceeds to Step 1209 in which the customer selects the store where the merchandise card can be used. The process after Step 1209 is as explained previously. FIG. 10 is an example of transaction verification screen 1010 which is displayed on the ATM screen in Step 1213 if the customer in Step 1201 selects a transaction to purchase a merchandise card.

In the process of subtracting “the designated amount plus the transaction fee minus the fee to be borne by the target store” from the customer's balance in Step 1214, the designated amount shall be considered to be equal to the amount of the merchandise card, and the same process as the preceding one will be implemented.

As explained above, the present invention provides a transaction fee management method and system for ATMs that lessens the ATM transaction fee for the customers, while enabling owners of stores to motivate ATM users to purchase the merchandise at the stores.

In the embodiment described above, the use of the ATM transaction fee system in retail shops such as convenience stores is described. However, the ATM transaction fee system in accordance with the present invention is also applicable to other business establishments such as restaurants, department stores, and the like.

Furthermore, in the embodiment described above, one or multiple points may be added to an ATM card owned by the customer each time the customer makes a purchase, and the points on the ATM card may be used to pay each applicable ATM transaction fee when the customer users an ATM.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A fee management method for managing ATM fees at an ATM that is installed at a business establishment and is connected to a server via a network, the fee management method comprising the steps of:
designating a transaction at the ATM and informing the server of the transaction via the network; and
making an indication to purchase a merchandise card if a transaction fee is charged for the transaction.

2. A fee management method according to claim 1, wherein the business establishment is a retail shop that sells merchandises to customers and the server is a bank server that manages bank transactions and ATM fee transactions.

3. A fee management method according to claim 1, wherein, in response to an instruction to purchase a merchandise card, the transaction fee is discounted.

4. A fee management method according to claim 1, wherein the amount of the transaction fee to be discounted is determined by the amount of the merchandise card indicated in the instruction of purchase.

5. A fee management method according to claim 1, wherein the amount of the transaction fee to be discounted is subtracted from an account of the business establishment at which the ATM is installed.

6. A fee management method for managing ATM fees at an ATM that is installed at a business establishment and is connected to a server via a network, the fee management method comprising the steps of:
designating a purchase of a merchandise card at the ATM and informing the server of the purchase via the network; and
when a transaction fee is charged for a transaction at the ATM, subtracting at least a part of the amount of the transaction fee to be discounted from an account of a business establishment where the merchandise card can be used.

7. A fee management method according to claim 5, wherein the entire amount of the transaction fee to be discounted is subtracted from the account of the business establishment.

8. A fee management method according to claim 6, wherein the business establishment is a retail shop that sells merchandises to customers and the server is a bank server that manages bank transactions and ATM fee transactions.

9. A fee management method for managing ATM fees at an ATM that is installed at a business establishment and is connected to a server via a network, the fee management method comprising the steps of:
adding at least one point to a card in response to a purchase of a merchandise;
inserting the card in the ATM, designating a transaction at the ATM and informing the server of the transaction via the network; and
when a transaction fee is charged for the transaction, paying at least a part of the transaction fee with the point of the card.

10. A fee management method according to claim 9, wherein the business establishment is a retail shop that sells merchandises to customers and the server is a bank server that manages bank transactions and ATM fee transactions.

11. A fee management method for managing ATM fees at ATMs that are installed at a plurality of business establishments and are connected to a server via a network, the fee management method comprising the steps of:
designating a purchase of a merchandise card at one of the ATMs and informing the server of the purchase via the network; and
when a transaction fee is charged for a transaction at the one of the ATMs, subtracting the amount of the transaction fee to be discounted from accounts of a plurality of business establishments according to a predetermined transaction fee division ratio where the merchandise card can be used.

12. A fee management method according to claim 11, wherein the business establishment is a retail shop that sells merchandises to customers and the server is a bank server that manages bank transactions and ATM fee transactions.

13. An ATM fee management system comprising:
at least one ATM that manages ATM fees, installed at a business establishment and connected to a server via a network, wherein the ATM comprises a section that designates a transaction, a section that informs the server of the transaction via the network, and a section that makes an indication to purchase a merchandise card if a transaction fee is charged for the transaction.

14. An ATM fee management system according to claim 13, wherein the ATM includes a section that calculates a discount from the transaction fee in response to an instruction to purchase a merchandise card.

15. An ATM fee management system according to claim 13, wherein the amount of the transaction fee to be discounted is determined by the amount of the merchandise card indicated in the instruction of purchase.

16. An ATM fee management system according to claim 13, wherein the amount of the transaction fee to be discounted is subtracted from an account of the business establishment at which the ATM is installed.

17. An ATM fee management system comprising:
at least one ATM that manages ATM fees, installed at a business establishment and connected to a server via a network, wherein the ATM comprises a section that designate a purchase of a merchandise card, a section that informs the server of the purchase via the network, and a section that, when a transaction fee is charged for a transaction at the ATM, subtracts at least a part of the amount of the transaction fee to be discounted from an account of a business establishment where the merchandise card can be used.

18. An ATM fee management system according to claim 17, wherein the entire amount of the transaction fee to be discounted is subtracted from the account of the business establishment.

19. An ATM fee management system comprising:
a plurality of ATMs that manage ATM fees, installed at a plurality of business establishments and connected to a server via a network, wherein each of the ATMs has a section that designates a purchase of a merchandise card, a section that informs the server of the purchase via the network, a section that calculates an amount to discount a transaction fee to be charged for an ATM transaction, and a section that, when a transaction fee is charged for an ATM transaction, subtracts the amount of the transaction fee to be discounted from accounts of a plurality of business establishments according to a predetermined transaction fee division ratio where the merchandise card can be used.

20. An ATM fee management system according to claim 19, wherein each of the ATMs includes a section that calculates a discount from the transaction fee in response to an instruction to purchase a merchandise card.

21. An ATM fee management system according to claim 19, wherein each of the ATMs includes a section that determines an amount of the transaction fee to be discounted based on the amount of the merchandise card.
